(19) United States
(12) Patent Application Publication
(10) Pub. No.: US 2010/0096204 A1
(43) Pub. Date: Apr. 22, 2010

(54) WHEELCHAIR TRANSPORTER OPERABLE BY WHEELCHAIR OCCUPANT IN THE WHEELCHAIR

(76) Inventors: George N. Mosey, Richmond, IN (US); Stephen A. Mosey, Richmond, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/252,410

(22) Filed: Oct. 16, 2008

(51) Int. Cl. B62D 61/06

(52) U.S. Cl. 180/210; 180/315

(57) ABSTRACT

A three-wheeled vehicle has a tilt-able platform, with walls on three sides and mounted to and supported by powered drive wheel portions of two motor scooters, one scooter at each side of the platform, and further supported by the front wheel assembly separated from one motor scooter and located at the front of the vehicle. The rear end of the platform has a tailgate. A handle on the platform is accessible to a wheelchair occupant to tilt the platform and fold the bottom-hinged tailgate downward to form a ramp so the wheelchair occupant can drive up the ramp and tilted platform to the front of the platform, returning it to level. Handle bars on the front wheel assembly are used for steering, and have throttle, horn, lights, turn signals, and braking controls for the wheelchair occupant to use while in the wheelchair to drive the vehicle on city and town streets and at speed ranges common to motor scooters.

### BACKGROUND

People whose mobility is limited to a wheelchair, have been disadvantaged in the respect of inability to travel any significant distances at any significant speed. Some efforts to deal with this problem are disclosed in some patents which are identified in the Information Disclosure Document to be transmitted at a later date. Better ways are needed, and the present invention addresses current problems.

### SUMMARY

A motor vehicle is provided with a chassis and at least three support wheels supporting a platform for travel along the ground. At least one of the wheels is a front wheel mounted to and supporting the front of the chassis. At least two of the wheels are rear wheels mounted to the chassis, one at each side of the platform and supporting the chassis. The platform is sized and shaped to receive and carry a hand-propelled or motorized wheelchair facing forward toward the front wheel of the vehicle. The platform is also close enough to the front of the vehicle for the wheelchair occupant, sitting normally in the wheelchair, to steer the vehicle. The wheels rotate on parallel or co-linear axes, and the front wheel is steer-able. At each side of the platform, there is a power plant including a power unit and some power transmission apparatus coupling the power unit to the wheel to drive the wheel. The platform is arranged for tilting the platform to facilitate moving a wheelchair from the ground upward and onto the platform by the occupant while sitting in the wheelchair. Then the vehicle can be driven by the wheelchair occupant sitting in the wheelchair.

### BRIEF DESCRIPTION OF THE DRAWINGS

FIG. 1 is a side view of a wheelchair transporter according to a typical embodiment of the present invention.

FIG. 2 is a top view of the transporter.

FIG. 2A is an enlarged fragment of FIG. 2 showing details of the wheelchair carrier platform mounting, and latching linkage as viewed from above.

FIG. 3 is a side view showing the transporter with the wheelchair receiver platform tilted and receiving the wheelchair being driven onto it by the wheelchair occupant.

FIG. 4 is a side view showing the occupant in the wheelchair with the wheelchair in place in the platform and the occupant ready to drive the transporter.

FIG. 5 is a rear view of the transporter with the wheelchair in place with the tailgate/ramp ready to be raised to the closed position shown in FIG. 4.

FIG. 6 is a rear view with the ramp/tailgate closed.

FIG. 7 is a schematic of linkage from an operating handle to the tailgate closing and platform lock-down mechanism.

FIG. 8 is front view of the transporter.

FIG. 8A is an enlarged fragment showing platform front support and platform lock-down features viewed from the front.

FIG. 9 is an enlarged fragmentary top view of a portion of the steering assembly and the steering damper connection to the steering handle bar mounting spindle and the vibration damper connected also to the front cross member.

FIG. 10 is a schematic diagram of the throttle, front brake, and rear brake control cabling.

FIG. 11 is an example of the instrument panel layout.

### DESCRIPTION OF THE ILLUSTRATED EMBODIMENT

Referring now to the several figures of drawing, the transporter 11 is a three-wheeled vehicle having a chassis 12, supported by a front wheel 13, and two rear wheels 14. Except for the platform 16, and tailgate/ramp 17, the wheels and portions of the vehicle chassis use two identical motor scooters currently available on the market. The scooters are used for support and driving the transporter with the rear wheels 14 of the scooters. One of the scooters is used for its front wheel, suspension, brake and steering assembly. Various sources of motor scooters are available to the public.

Referring further to the drawings, the steering assembly is removed from the front of each of the two scooters, and one of them is used for this transporter. The scooter frame has two generally parallel frame rails 19 extending horizontally downward from the rear ends 19A, downward at 19B and then horizontally forward at 19C and upward at 19D and converging toward the front. The steering assembly is normally secured to the converging front ends of the rails but, for the practice of the illustrated embodiment of the present invention, the steering assembly is cut away from the forward ends of the rails, and the rails are welded to the bottom of a tube 20 of rectangular cross-section. The same is done for the other scooter at the opposite end of the tube 20. The steering assembly removed from one of the scooters is subsequently attached to the front and top of the tube 20 as will be described hereinafter. The steering assembly from the other scooter is not used for this transporter.

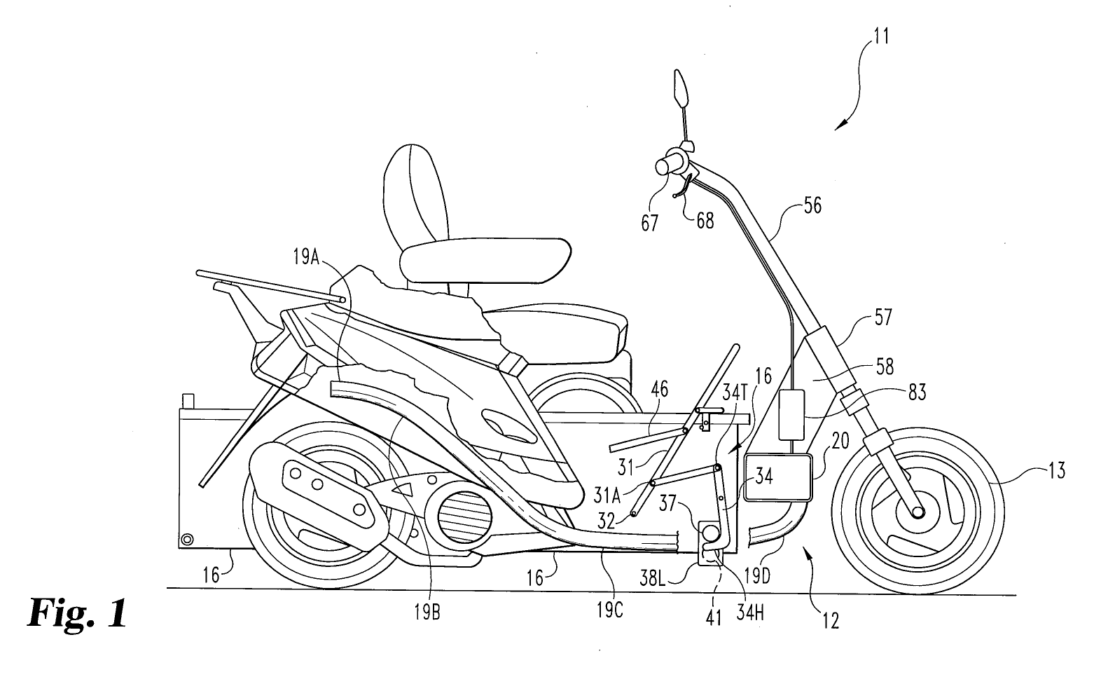

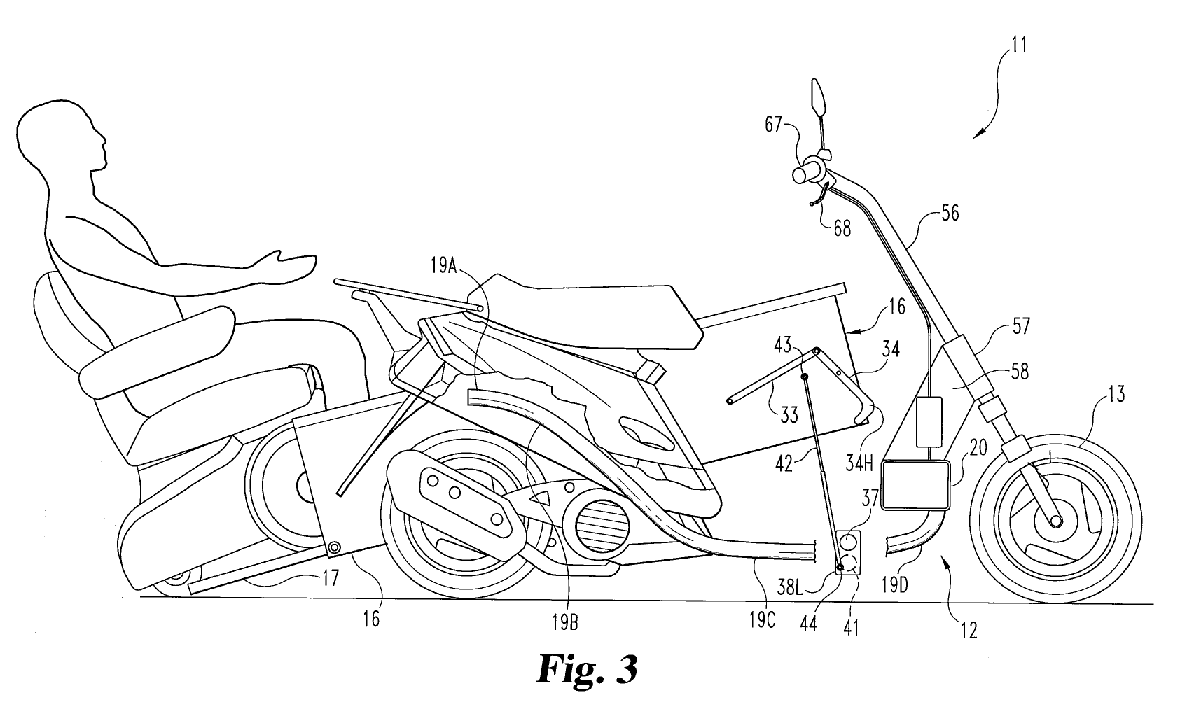

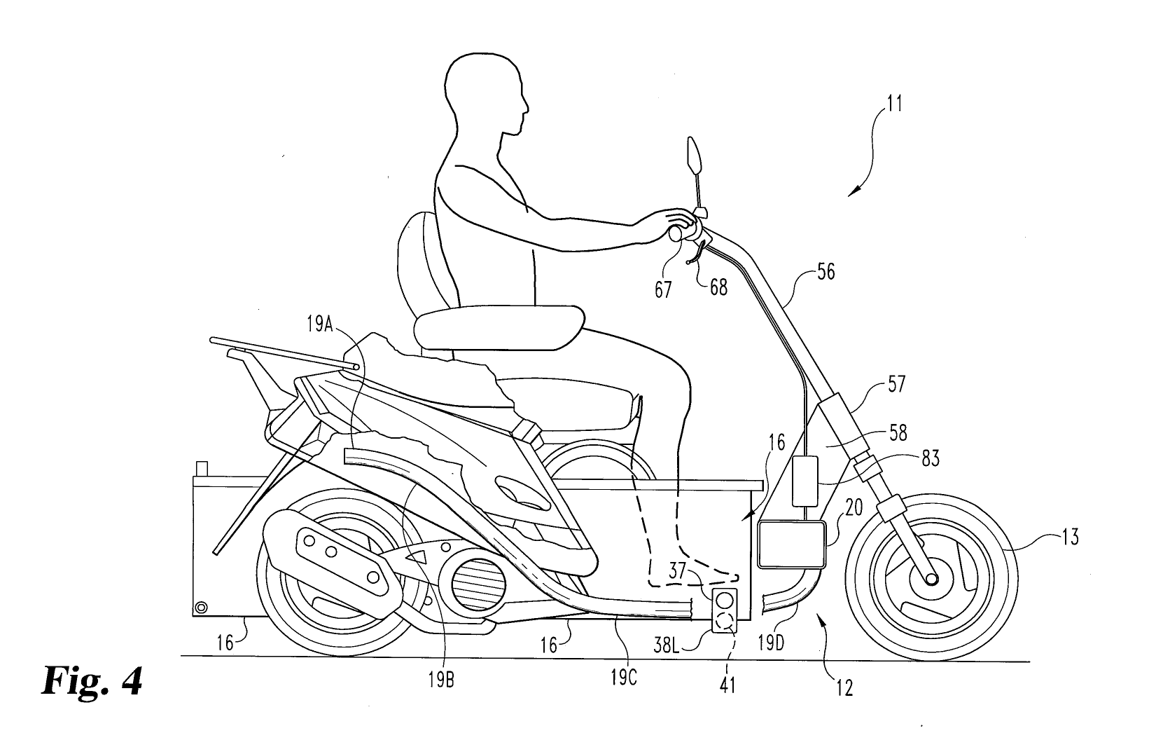

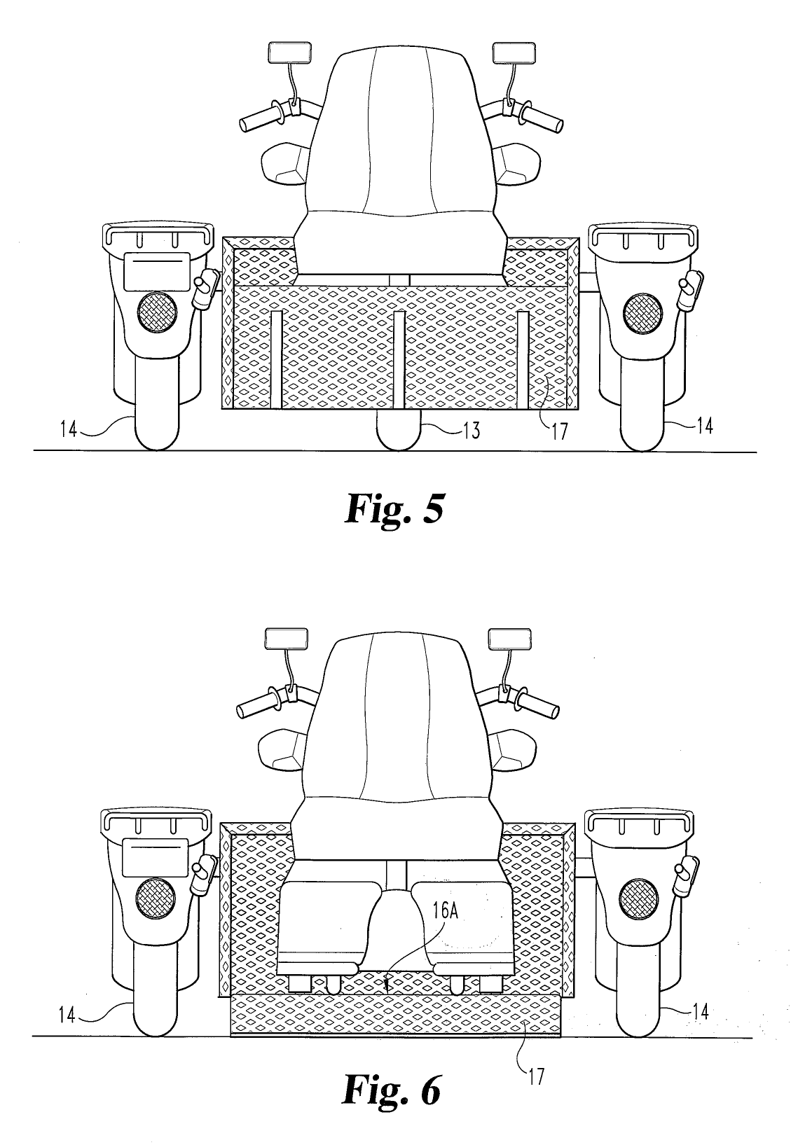

The wheelchair receiver platform 16 has a floor 16A and has upstanding walls 16B at the front, 16C and 16D at the sides. A panel 17 is hinged at the bottom rear and, when closed, as in FIG. 1, serves as a tailgate. It can be opened downward to serve as a ramp enabling rear entry access for a wheelchair to be driven by the occupant up the ramp and onto the wheelchair wheel-receiving floor 16A of the platform 16 as shown in FIGS. 3 and 4.

The platform is mounted to the scooters such that the ground clearance of the platform is three to four inches, for example. This provides a very low center of gravity for the transporter. It also enable the wheelchair receiver platform floor 16A receiving the wheels of the wheelchair to be as close as four inches above the ground. Also, the platform is mounted to the scooter such that, when the platform is empty and unlocked, it is tipped downward toward the back. These features assist the occupant to drive the wheelchair onto the platform regardless of whether it is an electrically-powered wheelchair or it is manually moved forward by the wheelchair occupant from the ground to the point where the weight of the wheelchair will tip the platform to the horizontal normal traveling condition of the transporter shown in FIGS. 1 and 4.

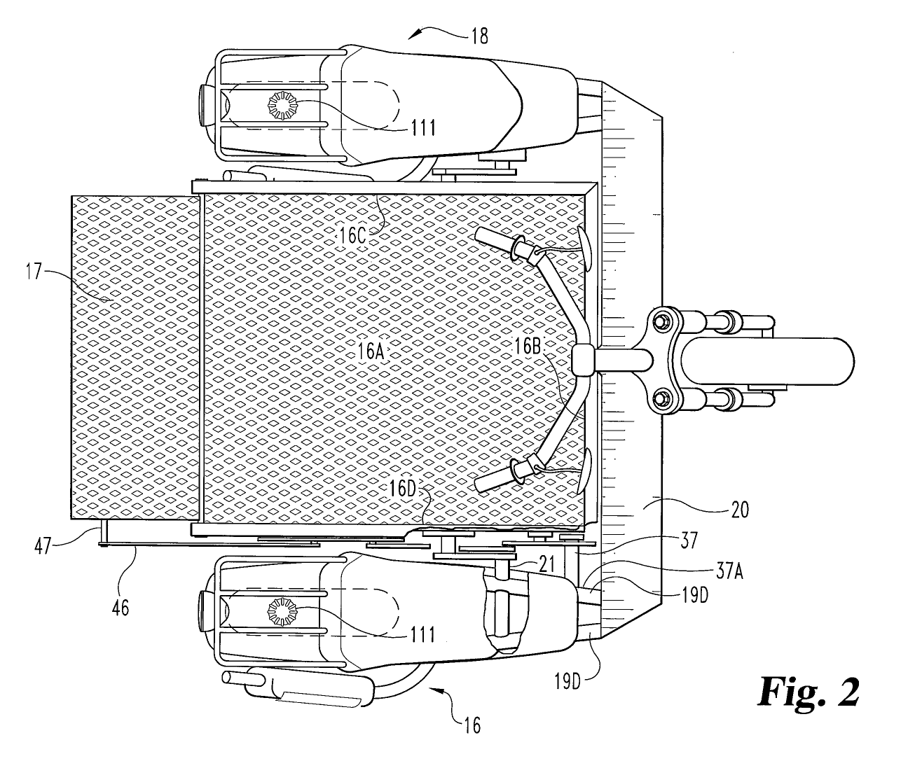

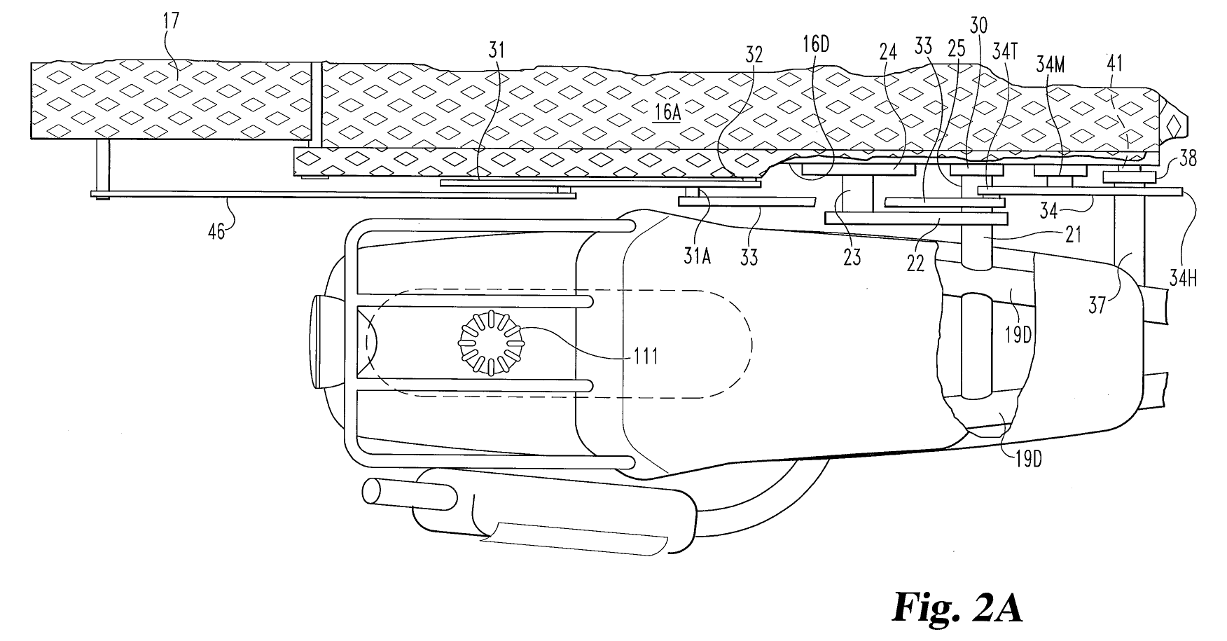

For the mounting of the platform to the scooters, a pin 21 is welded to the scooter inboard frame member 19D as shown in FIGS. 2 and 2A. A wheelchair platform pivot arm 22 is welded to the pin 21 and extends rearward. A post 23 is welded to the arm 22, and extends inward toward the platform. A plate 24 is welded to the upper portion of the outside face of wall 16D of the platform. That plate has a bushing or can serve as a bushing, receiving the post 23 for pivoting of the platform on the post 23. A stop pin 25 is fixed to the frame through arm 22. A stop block 30 is fixed to the wall 16D, and rests on top of the pin 25 when the platform is in the normal traveling condition. This same construction is used on the opposite side of the platform, thereby providing a pivotal connection of the platform to the scooters to enable pivoting from the traveling position of FIG. 1 to the tilted position of FIG. 3, and vice versa.

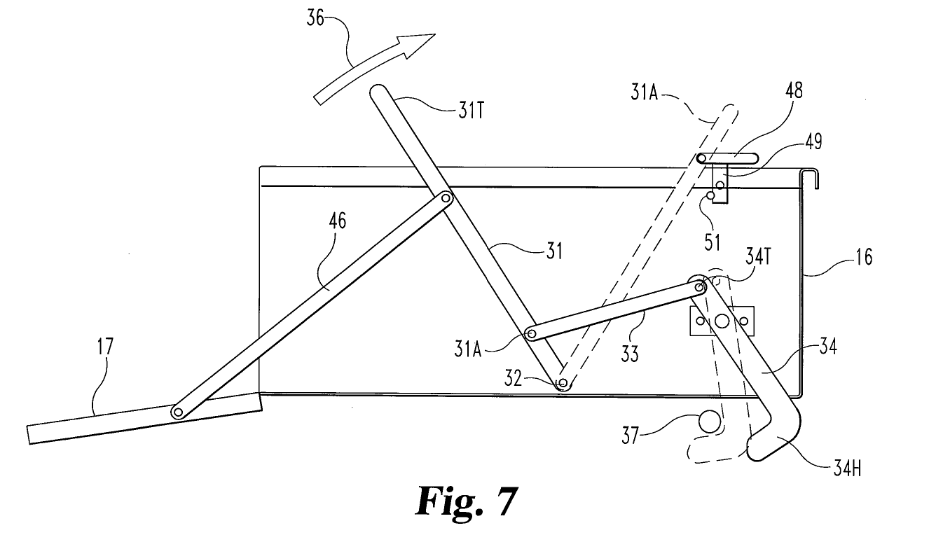

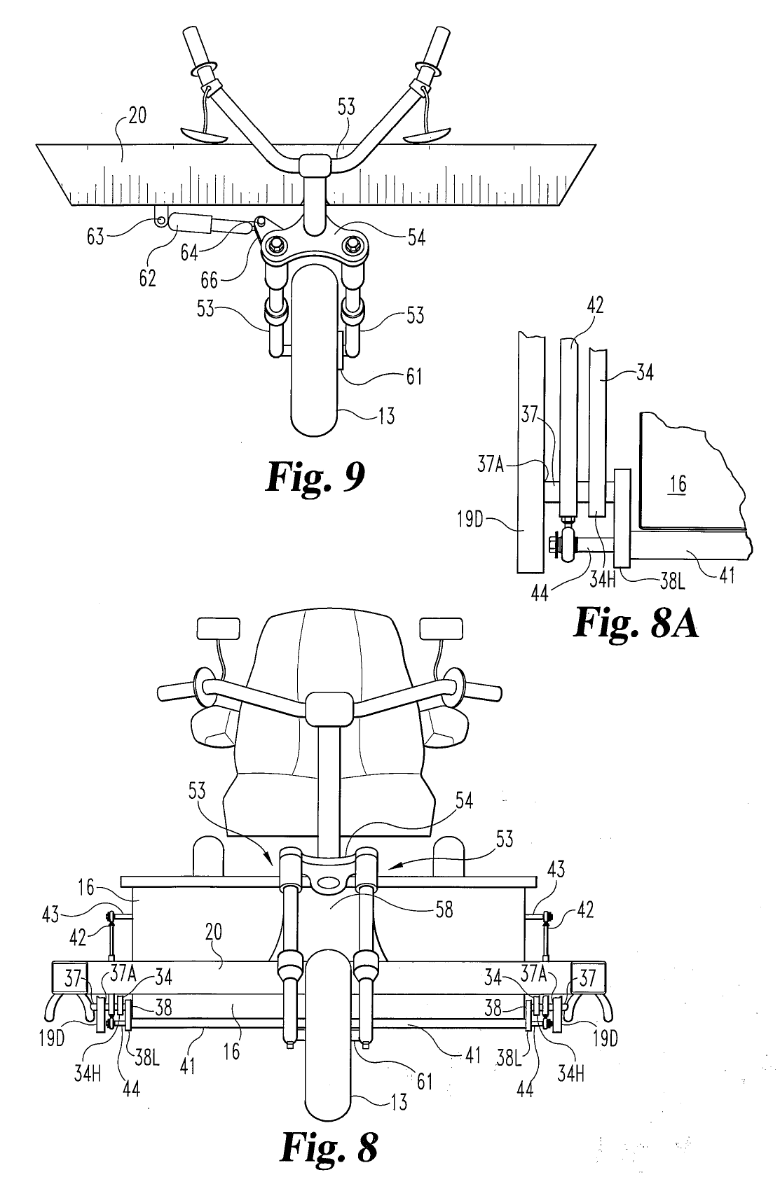

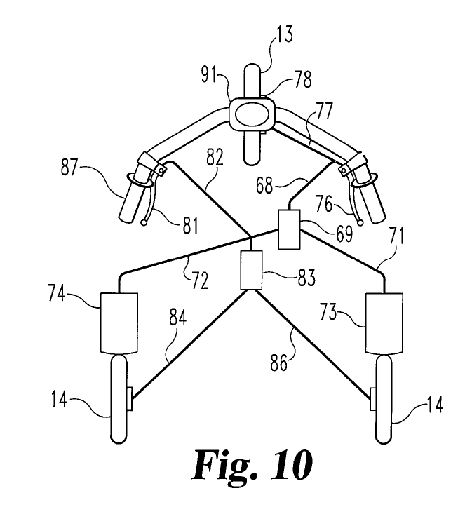

Referring to FIG. 7, it shows schematically the attitude of the platform and the tailgate/ramp when the wheelchair (not shown) has moved into place for the occupant to operate the transporter, but before the occupant operates a handle to simultaneously close the tailgate and lock down the platform. To be sure that the platform does not tilt up and backward during travel of the transporter over irregular terrain or bumps, for example, there is an arrangement for simultaneously closing the tailgate and locking the front of the platform down. This includes an operating handle 31 pivotally mounted at 32 to the right-hand side wall 16D of the platform. A link 33 is pivotally mounted to the handle 31 at 31A and extends forward to the top portion 34T of a latch arm 34 which is pivotally mounted at 34M to the side wall 16D of the platform. At the lower end of arm 34 is a hook portion 34H positioned such that, when the handle is moved forward in the direction of the arrow 36, the hook will engage a bar 37. As shown in FIGS. 8 and 8A, one end of bar 37 is welded at 37A to the scooter inboard frame rail 19D. The bar extends inward toward the platform 16. A hanger 38 is located adjacent the sidewall of the platform and has an upper end welded to the inner end of bar 37. The same construction is provided on the opposite side of the platform.

Referring further to FIGS. 8 and 8A, there is a crossbar 41 having ends welded to the inside faces of the lower end portions 38L of the hangers. This bar 41 supports the front end of the platform 16 when the platform is in the transporter traveling configuration. At that time, the hook portion 34H of latch arm 34 at each side of the platform is hooked under the bars 37 to prevent the platform from tipping upward during travel of the transporter. The pins 25 and stop blocks 30 mentioned above, are positioned with the blocks resting on the pins to provide additional support for the frontal portion of the platform if needed while traveling over bumps in the road.

Referring further to FIGS. 8 and 8A, a gas spring 42 has its lower end pinned to a post 44 fixed to the outer side of the lower end portion of the hanger 38. The upper end of the spring 42 is connected by post 43 to the outside face of the platform sidewall 16D. The same arrangement can be provided on the left-hand side of the platform. This spring constantly urges the front portion of the platform upward so that, when the wheelchair is out of the transporter, the platform will remain tipped up as in FIG. 3, ready for return of the wheelchair for resuming travel in the transporter.

Referring again to FIGS. 2, 2A and 7, a further link 46 is pivotally connected to the handle 31 and connected to the tailgate 17 at 47 so that when, the handle is moved forward in the direction of arrow 36 (to the dashed lines position) as mentioned above, to latch down the front end of the platform to the bar 37, the tailgate will be closed to the condition shown in FIGS. 1 and 4. A tailgate safety latch 48 includes a portion 48A pivotally attached to the handle 31 near the top, and has a hook portion 49 engagable with a pin 51 fixed to the side of the platform 16 so that, when the handle 31 is pushed forward to close the tailgate and hook the arm 34 to the bar 37, the platform is locked down and the tailgate locked closed.

Referring further to FIG. 8, the front wheel 13 has an axle assembly 52 supporting a fork comprising two combination spring and shock absorber units 53 whose upper ends are fixed to a yoke 54 connected to a steering shaft 56 mounted for rotation in a sleeve 57 supported by a pylon 58 fixed to the top of the cross member tube 20. A front brake assembly 61 for the front wheel 13 is secured to one of the two shock assemblies 53.

Referring now to FIG. 9, a steering damper 62 has one end pivotally mounted at 63 to the cross member 20. The piston rod end of the damper 62 is pinned at 64 to an arm 66 fixed to the yoke 54.

Referring further to FIG. 9 along with FIG. 8, the right-hand twist grip 67 on the right handle bar operates the throttle control wire 68 entering a wire splitter 69 from which wires 71 and 72 go to the engines 73 and 74, respectively. The right-hand lever 76 is cabled at 77 to the front wheel brake 61. On the left handle bar, the hand lever 81 is cabled at 82 to the brake splitter 83 from which cables 84 and 86 extend to the rear wheel brakes on the left and right-hand wheels 14.

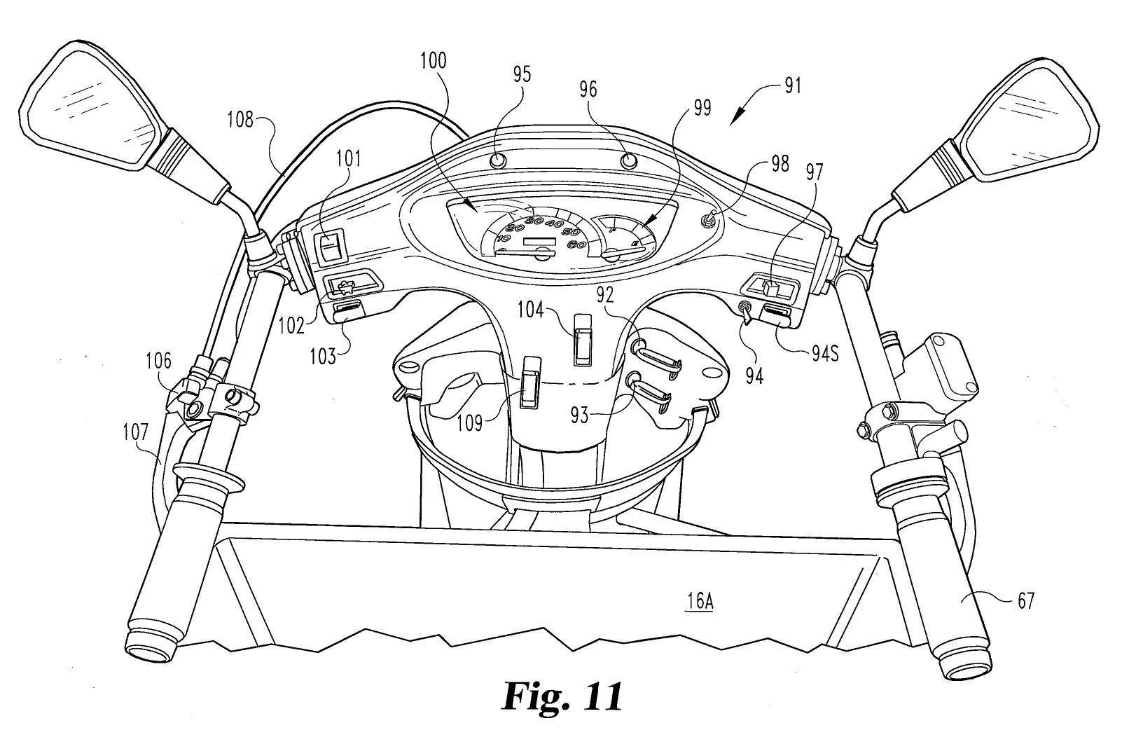

Since some of the mechanical and most of the electrical connections of the original motor scooters to their instrument panels are to be consolidated on the single steering wheel assembly on this transporter, a single instrument panel 91 is mounted on the handlebars and illustrated schematically in FIG. 11. Since each of the scooters is complete except for the front wheel and steering assembly, duplication of some of the front-end components is not necessary for the transporter. However, for each engine, there is a key-operated ignition switch 92 and 93. There is a two-position, bi-stable selector switch 94 for the right or left engine, and a start button 94S for the selected engine. While the transporter is preferably operated with both power systems running, it can be used with either the left or right power system individually. The described method of construction of this transporter provides a very useful redundancy in the sense of fuel supply, brakes, lights, storage, battery charging and power. Because of the fact that the two scooters have seats on them, it also enables the transporter to carry two passengers, if desired. In that case, it would be preferable to have two, non-steering handlebars or other devices to which the passengers can be secure. Also, the location of the fuel tank filler cap 111 at the usual place on some of these motor scooters, which is near the rear end of the seat and behind a storage chamber under the seat, may enable the driver to access service station pumps without getting out of the wheelchair. There are left 95 and right 96 engine-running indicator lights. There is a kill switch 97 to shut off both engines. Since each scooter has its own fuel tank, a fuel content sensor is provided on each and coupled to a bi-stable switch 98 on the panel, and which is connected to a fuel supply indicator 99 on the panel. The switch enables one to check the tank contents separately with just one indicator. A speedometer 100 from one of the scooters is also included on the panel. There is a rocker switch 101 for low/high headlight beam selection, a turn signal switch 102, and a horn button 103.

Since each of the scooters has its own battery, and magneto for charging the battery and providing for other electrical requirements, it is considered desirable to enable the magneto on one side to be able to supply electrical power to the other side in case there is a low battery or disabled engine on that side. For that purpose, a selector switch 104 may be provided on the panel 91 and which can have three positions, one to connect the magneto of one scooter to the other scooter in the event of battery or magneto failure of the other scooter to thereupon supply both scooters, and vice versa, and a neutral position separating the magnetos.

For parking brake, an emergency brake mechanism 106 is mounted to the rear brakes control lever 107, and is useful to block the lever in the brakes-applied position to park the transporter. A reverse switch 109 may be provided if the transporter is to be equipped with a reverse feature. The switch would normally be provided with a protective cover to avoid inadvertent activation while the transporter is traveling.

Although torque-converter transmissions of the mechanical type provide power transmission from the engines to the rear wheels in this illustrated embodiment, other types of transmissions might be used if the present invention is to be embodied in a transporter vehicle by using components other than modified motor scooters. Some other examples are a hydraulic torque converter, a hydrostatic transmission, an electrical, or a hydraulic transmission. A windshield can be mounted on the chassis or, more likely, on the handlebar assembly.

The illustrated embodiment of the transporter has a tight-turning radius of 3.5 feet.

The term “motor scooter” is used herein, as a general term for a vehicle usually understood as one with a step-through type of frame, and having an engine displacement of less than 160 cc per engine. For a wheelchair transporter which is not assembled from motor scooters commercially available on the market, the power of each of the two power units covered herein would not be so limited.

What is claimed is:

1. A motor vehicle comprising:
a platform having a front and a rear and sized and shaped to receive and retain a wheelchair on it;
at least first, second and third wheels supporting said platform for travel along a surface, and wherein said third wheel is a front wheel and said first and second wheels are rear wheels, and said front wheel normally rotates on an axis parallel to axes of rotation of said rear wheels, and said front wheel is steer-able to change its rotational axis out of parallel with the rotational axes of said rear wheels, to change direction of travel of said platform along said surface;
first and second power sources;
first and second power transmission devices coupling said first and second power sources to said first and second wheels respectively;
a wheelchair wheel-receiving and supporting area on said platform and having a location for a wheelchair on said platform between said rear wheels and near the front of the platform for transport of said wheelchair on said vehicle platform;
a steering control coupled to said steer-able wheel and operable by an occupant seated in said wheelchair at said location on said platform, to steer the platform while using said power sources to drive said wheels and thereby drive the vehicle while carrying the wheelchair on said platform with its occupant seated in the wheelchair and driving the vehicle.

2. The vehicle of claim 1 and wherein:
said wheel receiving area is at a level below axes of rotation of said first and second wheels.

3. The vehicle of claim 1 and wherein:
said wheel receiving area is less than five inches above wheel supporting ground.

4. The vehicle of claim 1 and wherein:
support of said platform by said second wheel is independent of support of said platform by said first wheel.

5. The vehicle of claim 1 and wherein:
said first and second power sources, power transmissions, and wheels are components of first and second motor scooters; and,
said steering control is a component of one of said motor scooters.

6. The vehicle of claim 5 and wherein:
said power source of each of said scooters is an internal combustion reciprocating engine of maximum displacement less than 160 cc.

7. The vehicle of claim 5 and wherein:
the dry weight of each of said scooters used in said vehicle is no greater than about 100 kg.

8. The vehicle of claim 5 and wherein:
each of said scooters has a battery and a battery charger, and
said vehicle has a switch arranged to enable the charger of one of said scooters to charge the battery of the other scooter.

9. The vehicle of claim 5 and wherein:
each of said scooters has a fuel tank; and
said vehicle has a fuel gauge switchably coupled to said fuel tanks to separately monitor remaining fuel in each tank.

10. The vehicle of claim 5 and wherein:
each of said scooters has a fuel tank with a fuel filler opening accessible to said occupant while seated in said wheelchair on said platform.

11. The vehicle of claim 5 and wherein:
each of said scooters has a seat, whereby two persons can ride on the seats while the wheelchair occupant drives the vehicle.

12. A method of making a wheelchair transporter and comprising:
making a chassis assembly comprising two longitudinal side members and a first cross member fixed to front ends of said side members;
pivotally mounting said platform to said chassis side members to pivot on an axis which is generally horizontal, and perpendicular to said side members;
securing supports to said side members for support of a front portion of said platform ahead of said pivotal mounting;
providing two combinations of power plant, transmission, and rear road wheel;
mounting one of said two combinations at each side of said platform; and
mounting said first cross member to an assembly of a front road wheel and steering apparatus to support a front portion of the transporter.

13. The method of claim 12 and further comprising:
securing said supports as hangers fixed to said side members near said front ends of said side members; and
securing a second cross member to said hangers and under a front end portion of said platform to support said front end portion of said platform.

14. The method of claim 12 and further comprising:
locating, for said mounting of said platform, pivots on said side members at locations whereby a front of said platform pivots upward in the absence of a wheelchair supported at a front portion of said platform.

15. The method of claim 12 and further comprising:
locating, for mounting said platform, pivots high enough on said side members that said rear portion of said platform hangs from said side members.

16. The method of claim 12 and further comprising:
providing front and side walls on said platform and a tailgate at the rear of said platform;
providing a linkage with a hook to lock down the front of said platform, and a link to operate the tailgate, and a manipulator accessible to a wheelchair occupant while sitting in a wheelchair at said front portion of said platform; and
connecting said linkage and link to said manipulator to enable the wheelchair occupant to lock down said platform to be substantially parallel with said plane, and to lock said tailgate closing the rear of said platform.

17. The method of claim 12 and further comprising:
using two motor scooters for said side members.

18. The method of claim 12 and further comprising:
using two motor scooters for said two combinations.

19. The method of claim 12 and further comprising:
locating a wheelchair wheel-receiving and supporting area of said platform less than five inches above ground supporting said rear road wheels.

20. The method of claim 12 and providing less than four inches road clearance from said platform to ground supporting said road rear wheels.
